(19) United States
(12) Patent Application Publication
(10) Pub. No.: US 2005/0147131 A1
(43) Pub. Date: Jul. 7, 2005

(54) Low-rate in-band data channel using CELP codewords

(75) Inventor: Steven Craig Greer, Rowlett, TX (US)

Correspondence Address: HARRINGTON & SMITH, LLP, 4 RESEARCH DRIVE, SHELTON, CT, 06484-6212, US

(73) Assignee: Nokia Corporation

(21) Appl. No.: 10/748,874

(22) Filed: Dec. 29, 2003

(51) Int. Cl. H04J 3/12

(52) U.S. Cl. 370/522

(57) ABSTRACT

A codebook 58 includes a first subset of M codewords 82 and a second subset of N-M remaining codewords 84. Codewords in the first subset are used for signaling a beginning or end of an in-band stream of data. Designated frames 90 make up the stream and include both speech and data. Each codeword index defines L bits that are used to encode speech. Within the designated frames, D bits of the L bits carry data and the remaining L-D bits are used to search from a truncated number of codewords uniquely identifiable by the L-D bits. The designated frames may be a set number of consecutive frames, or the set number of frames dispersed to recur once every 1/K frames. The number of designated frames may be extended by re-transmitting a codeword from the first subset, or truncated by transmitting a stop codeword that is also within the first subset of codewords. All of the L bits are available to search the codebook in non-designated frames that do not carry data. Data rate and effective codebook size may be selected by the various codewords of the first subset.

### FIELD OF THE INVENTION

The present invention relates to fixed or variable rate transmissions over packet or circuit switched networks. It is particularly adapted to wireless voice communications over a packet switched network, though it may be used for any application wherein data and speech (or other substantive user-related information) are sent within the same packet or frame.

### BACKGROUND

Cellular voice communication is conveyed almost exclusively via speech that has been digitized and compressed using a speech coder/decoder (codec). Most, if not all speech codecs used in these cellular systems are based upon a technique known as code excited linear prediction (CELP). CELP-based speech encoders represent speech in a parametric fashion by analyzing a particular segment, or frame of speech and generating coefficients of a filter used to recreate the speech in the speech decoder. The speech encoder also selects, from a large codebook, a codeword that is used to provide an excitation to this filter. The speech codec selects the optimum codeword from the codebook that maximizes the quality of the particular frame of encoded speech.

In certain cellular networks, speech communication is conveyed over circuit-switched links, or links that are reserved for the duration of the call. Unlike circuit switched connections, packet switched connections for voice communications can substantially reduce bandwidth when the speakers on a call are momentarily silent. However, packet switched networks have traditionally been developed to be high speed, low error, bursty, and delay insensitive. Circuit switched voice data is generally transmitted at lower speed, has a higher error tolerance, is non-bursty, and is sensitive to excessive delay.

It is widely anticipated that packet-switched networks will dominate the future of telecommunications. For the voice communication case, end-to-end Voice over Internet Protocol (VoIP) enables packets of speech to be transferred from a transmitter to a receiver without re-encoding by a network entity such as a base station (BS). Currently, most telecommunication systems use packet switching for data and circuit switching for voice.

One of several standards in use today for mobile communications is cdma2000, which includes a channel for transporting data packets over an air interface. Mobile systems using cdma2000 provide voice communication in a circuit-switched manner. Signaling over an air link between a BS and a MS associated with circuit-switched communication under cdma2000 is either sent in-band, reducing speech quality, or sent out-of-band, adding to the bandwidth required for communication.

Specifically, for circuit-switched speech in cellular systems such as cdma2000, signaling information is sent over an air link in one of three ways: 1) dim and burst; 2) blank and burst; or 3) a separate signaling channel. In dim and burst, the variable rate speech codec is forced to transmit at half rate while the other half of the bits are used for signaling. In blank-and-burst, the entire full rate frame of the speech codec is replaced by signaling bits. Each of these two approaches result in degradation of voice quality at the time that signaling information is sent. Additionally, blank-and-burst necessarily results in a missed frame at the decoder. The third method, where a separate signaling channel is set up for the sole purpose of transmitting signaling information, results in additional bandwidth used to send signaling information out-of-band. All of the above three methods require network entities, such as BSs, to compress, translate, and otherwise actively modify the content of the communication, rather than passively transfer the digital packets as is done in packet-switched networks.

What is needed in the art is a method and system to perform signaling over either circuit-switched or packet-switched networks, such as VoIP, that does not require additional bandwidth (it should be in-band), and that does not compromise speech quality. Preferably, such a system and method would be invisible to network entities for mobile-to-mobile communications, and would not be limited to voice communications but can be used for signaling for any mobile communications, including uploads and downloads to the internet or a LAN, email, short message service, and other non-voice data.

### SUMMARY OF THE INVENTION

The present invention solves the problem of out-of-band signaling and minimizes the reduction in speech quality by using the codewords transmitted by the speech encoder as a means for transmitting non-speech data.

The use of an in-band low-rate data channel that provides minimal, or no perceptible degradation to the quality of speech can also be used in a number of new ways, especially in a VoIP-based system: enabling new applications using low-rate data that are transparent to the cellular system; communicating information between speech codecs, for example, in an effort to improve link quality.

This invention uses the CELP-based speech codec to create an in-band data channel for signalling information or other data applications that may generally be compatible with low data rates. Data is sent in-band in such a way that voice quality degradation is minimal and is controlled. This invention can be used, for example, in a cdma2000 circuit-switched system to convey signalling information that is currently transmitted either in-band via dim-and-burst or blank-and-burst, or out-of-band in a specially dedicated signalling channel. For the scenario of end-to-end packet communications, this invention is broad enough to enable many currently unforeseen applications involving mobile-to-mobile communications.

In general, a CELP-based speech codec includes N=2^{L} codewords, each uniquely identified by a codeword index defining L bits. In the prior art, each of the L bits are used to search the entire codebook for the codeword that best fits the speech to be coded, and only the index is transmitted. For example, assume a speech codec with N=8 codewords. While each codeword may in fact contain fifty bits, only the L=3 bits (8=2³) are transmitted that uniquely identify the codeword. In the present invention, a portion of the index bits carry data while within the in-band stream, and the remainder of the L bits are used to search the codebook for a codeword that best fits the speech to be encoded or decoded. The in-band stream of data is itself identified by designated codewords used for that purpose.

The present invention is in one aspect a method of providing in-band data within a digital speech channel. The method includes storing a codebook in a computer readable medium. The codebook has N codewords, each identified by a codeword index defining L bits, so N=2^{L}. In the method, a designated codeword of the codebook is used to identify a stream of in-band data, preferably a start and optionally a stop of the stream. The designated codeword is identified by its index. The stream of in-band data is defined by at least one designated frame in which in-band data is carried, and preferably more than one such designated frame. In the at least one designated frame, a first portion D of the L bits of a codeword index are used to carry data. Also in that same designated frame, a second portion L-D of the bits of the index, are used to uniquely select a codeword from the codebook. Since each codeword is chosen based on its entire L-bit address in the codebook, the entire L bits are used to select a codeword even though only L-D of those bits are available to select a unique codeword. The first portion and the second portion of the bits of the codeword index are mutually exclusive. Because the L-D bits can only uniquely identify 2^{L-D} codewords, speech quality is slightly degraded while within the in-band data stream, the designated frames. Within the non-designated frames, all of the L bits of the index are available for searching the codebook, but only the codewords that do not designate a start or stop of an in-band stream are available outside the in-band stream of data. Since relatively few codewords designate the in-band data mode, speech quality outside the in-band stream is negligibly affected.

Preferably, various designated codewords are used to select varying combinations of in-band data rate and effective codebook size for the in-band stream of data. Where a group of designated codewords select the same data rate and effective codebook size (within the in-band stream), the encoder and decoder are enabled to select from any within the group for the frame carrying the designated codeword or its index. This avoids the encoder and decoder from being constrained to only one codeword for that frame in which the stream is started or stopped, since they translate that frame into speech as any other non-designated frame.

The designated frames need not be consecutive, and need not start in the frame immediately following the frame bearing a designated start codeword. Preferably, at least one of the designated codewords indicates an end to the stream of in-band data, either to terminate a stream that is not needed in its entirety for the particular data, or to signal the end of the stream when a start codeword indicates an open-ended or continuous stream of in-band data. The in-band data is constrained to a maximum rate of the codebook indices being transmitted.

Another aspect of the present invention is a transmitter that has a codebook of N=2^{L} codewords and an encoder. Each codeword index has L bits that uniquely identify the codeword over other codewords in the codebook. The encoder encodes speech into frames using the codebook. The present invention improves over the prior art in that the encoder uses a designated codeword to identify a stream of in-band data. The stream is defined by at least one designated frame in which speech and data are carried. Specifically, within the designated frame, the encoder encodes data using a first portion D of the L bits of a codeword index. The encoder may select a codeword using a second portion L-D of the L bits of the index, which is mutually exclusive to the first portion of bits. As above, the designated frames may or may not be consecutive, different designated codewords may designate different combinations of in-band data rate and effective size of the codebook for the in-band stream, and a stop codeword may be used to truncate a stream that is not to be fully utilized or that is initiated as a continuous stream. Various other embodiments offer different balancing of advantages and drawbacks.

The present invention is, in another embodiment, a receiver that has a codebook of N=2^{L} codewords and a decoder. Each codeword index defines L bits that uniquely identifies each codeword over other codewords in the codebook. The decoder uses the codebook to decode speech. The present invention improves a receiver as compared to the prior art in that the decoder decodes a designated codeword in a first frame that identifies an in-band stream of data. While the receiver receives only the codeword index, the decoder uses the index to select a codeword from the codebook. The in-band data stream defines at least one designated frame in which both data and speech are carried. The decoder decodes data in the designated frames using a first portion D of the L bits of the codeword index. A second portion L-D of the L bits is then available to the decoder to search the codebook to decode the speech in the designated frame. By the above, the data is carried in the D bits. Since each codeword is identified by an index of length L, the entire L bits are used to select a codeword, though only L-D bits are available to uniquely (effectively) select a codeword. As with the transmitter and the method, various designated codewords can be used to select different values for D, and consequently different data rates and effective codebook size for the in-band stream.

### BRIEF DESCRIPTION OF THE DRAWINGS

FIG. 1 is a prior art schematic diagram of a network that may employ the present invention.

FIG. 2 is a block diagram of a mobile station that uses a codebook according to the present invention that is stored in flash memory.

FIG. 3 is an illustration of a codebook consisting of N codewords, of which a subset M codewords are reserved for designating a stream of in-band data in accordance with the present invention.

FIG. 4 is codeword index i of length L bits partitioned according to the present invention wherein, of the L bits that are normally used to select a codeword, a portion D of them are also used to carry in-band data in designated frames.

FIG. 5A-C is a series of frames showing how the stream of in-band data can be dispersed over consecutive or non-consecutive frames.

### DETAILED DESCRIPTION

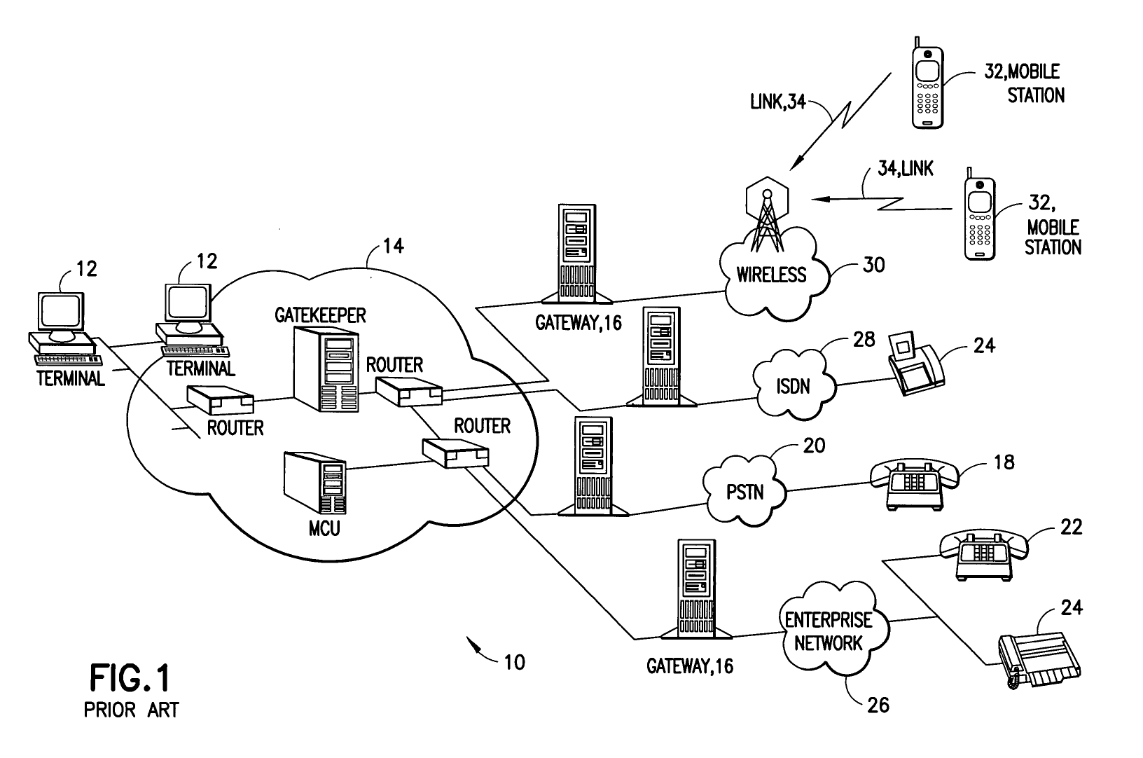

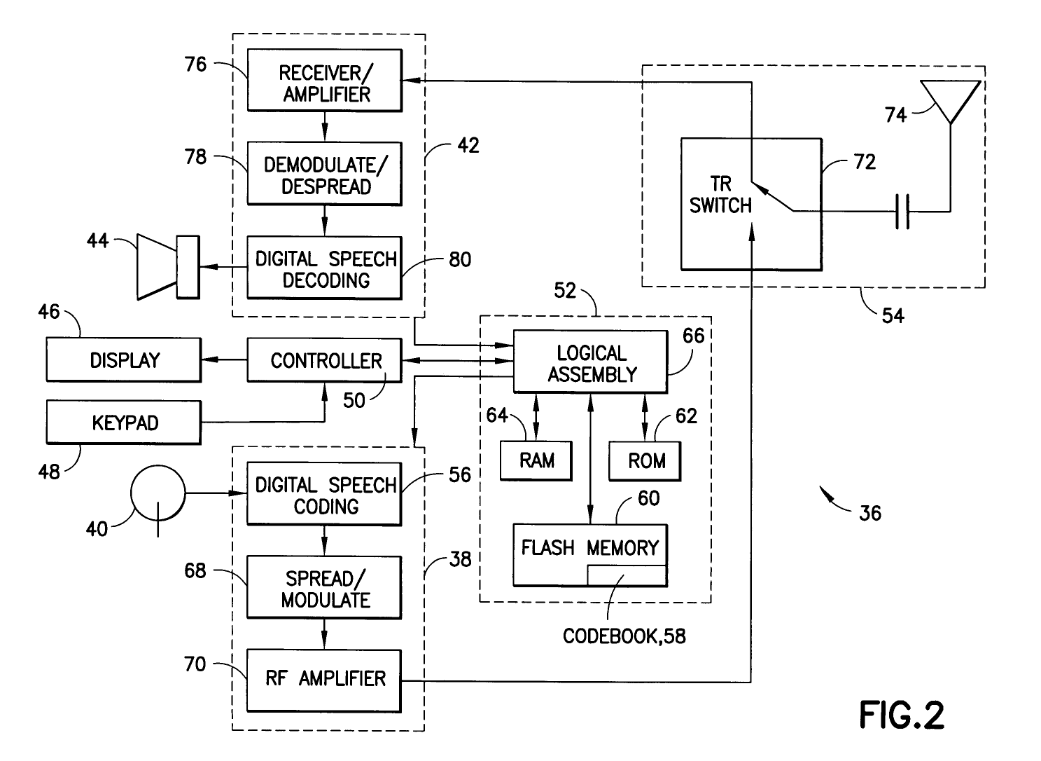

FIGS. 1-2 are schematics illustrating an overview of the environment in which the present invention may be employed. FIG. 1 is a schematic diagram of a prior art network 10 having elements interconnected to communicate with one another using packet switching and circuit-switching. Computer-based phone terminals 12 are LAN based endpoints for packetized voice transmissions that include at least one encoder/decoder (codec), such as a PC running NetMeeting™ software by Microsoft™ and an Ethernet enabled phone. Computer based phone terminals 12 may also implement video and other non-speech data communication capabilities. A plurality of access elements 14, such as routers, gatekeepers, and a multipoint control unit (MCU) operate to connect the terminals 12 to broader elements of the network 10.

A plurality of gateways 16 connect packet-switched networks to more traditional speech networks, such as circuit switched networks. An example is the gateway 16 in series with the traditional telephone 18 through a public switched transmission network 20 (PSTN). Gateways 16 may also interface with other network elements 22, 24 (which may include, for example, faxes, scanners, digital video cameras and security monitors) through an enterprise network 26, an integrated services digital network (ISDN) 28, or a wireless base station (BS) 30 that services mobile stations (MSs) 32 and other wireless devices through a wireless link 34. MSs 32 may communicate directly with one another via a BS 30. Where both MSs 32 are within the purview of a single BS 30, they may communicate without using additional network components. Otherwise, additional network components are used to facilitate mobile-to-mobile communications. It is expected that the advantages afforded by the present invention will be most pronounced in mobile-to-mobile communications.

FIG. 2 illustrates in block diagram a transceiver 36, which is assumed for convenience, but not by way of necessity, to be contained within a MS 32, such as a personal communicator depicted in FIG. 1. The transceiver 36 includes a transmitter 38 coupled to a microphone 40, a receiver 42 coupled to a speaker 44, a display 46 and keypad 48 coupled to an interface controller 50, a central processing unit (CPU) 52, and a T/R unit 54. The CPU 52 is coupled to the transmitter 38, the receiver 42, and the interface controller 50. Speech signals from a user of the transceiver 36, input to the microphone 40, are digitally encoded at a digital encoder 56 using a codebook 58 that may be stored in flash memory 60, or alternatively in read-only memory 62 or random-access memory 64, or any other computer readable storage medium. A logical assembly 66 searches the codebook 58 for the most appropriate codeword to digitize each particular segment of speech. The encoder 56 encodes the index (i) that uniquely identifies the selected codeword among the codebook 58, so in transmission the index (i) is used to represent the digitized speech. The encoded digital speech signal is spread into packets among the entire bandwidth and modulated onto a carrier signal at a spreader 68, amplified at a RF amplifier 70, and passed to the T/R unit 54 where a T/R switch 72 connects the transmitter 38 to an antenna 74, thereby transmitting the digitized message to a BS 30 or other network entity described in FIG. 1. FIG. 2 is an example only as the present invention may be used with a MS 32 employing CDMA, TDMA, FDMA, or any multiple access scheme. Any such MS 32 will include a codebook 58 stored in some memory 60, 62, 64.

Communication received at the antenna 74 is directed by the transmit/receive (T/R) switch 72 to the receiver 42, where it is amplified by a receiver amplifier 76, demodulated and de-spread at a despreader 78, and decoded at a decoder 80. The decoder 80 decodes the codeword index (i), which is then used to search the codebook 58 at the receive end of the communication for the same codeword that was selected at the transmit end. The particular codebook 58 used for decoding is identical to the one used for encoding for a single two-way communication such as a voice phone conversation. Any entity communicating over the network, such as the MS 32, may store more than one codebook 58. The codeword identified by the decoded codeword index (i) is used to generate digital speech that is converted to audio at the speaker 44 where it is intelligibly received by the user.

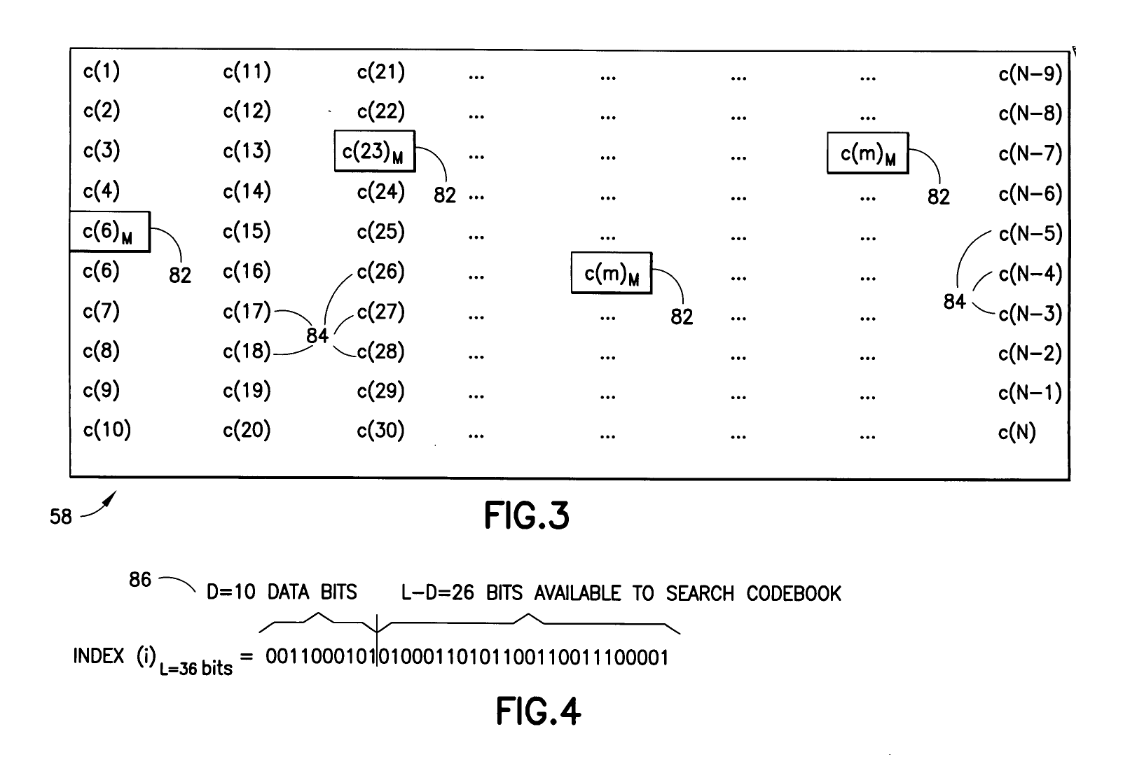

FIG. 3 is an illustration of a codebook 58 such as was noted in FIG. 2. It is stipulated that codebooks 58 may be stored in a computer readable medium in many forms, such as the table illustrated in FIG. 3, or generated by a stored algorithm, to name but two. The present invention is not limited in the particular form, storage location, or storage medium of the codebook 58.

In general terms, any CELP-based codec uses a codebook 58 consisting of a large number of codewords c(i), where i is a codebook index and 1<i<N. As described above, the codeword index (i) is used in the prior art to uniquely identify one codeword c(i) from among the entire codebook 58, and can be considered an address of the codeword c(i). While the codeword c(i) may be of arbitrary length, the size of the index (i) is dependent upon the number of codewords c(i) in the particular codebook 58. For N codebook indices, L is the number of bits used to represent the index, where 2^{L}=N as noted above. The length of the codeword c(i) itself is not necessarily related to the length L of the index (i), and while the codewords themselves may be non-binary in a particular codebook, in essentially all cases the codeword index (i) is binary. FIG. 3 shows a codebook 58 defining N codewords, each identified as c(i). In accordance with the present invention, the codebook 58 is divided into two mutually exclusive sets: a first subset that consists of M codewords designated by reference number 82 (shaded codewords using subscript M), and a second subset that includes the remaining codewords not within the first subset and designated by reference number 84. The value of M (the number of codewords within the first subset) may represent the number of different modes or data rates available to transmit in-band data, as detailed below.

In the prior art, the speech encoder 56 will choose, for each frame or subframe of speech, the optimal codeword from all of the N codewords that maximizes the quality of speech. Depending on the multiple access scheme in use by the transmitter, the frame or subframe may be transmitted as a frame, or they may be assembled into packets for transmission. The present invention reserves the first subset 82 of M codewords for use as mode selection and speech coding. As used herein in the context of voice communications, the terms data refers to non-speech aspects of the communication, and may carry signalling information, short messaging service, email, etc.

When the total number of codewords N in a codebook is relatively large, limiting the size M of the first subset 82 to a small number negligibly impacts speech quality. M=9 is selected as an example in the description below, though not all nine codewords are depicted in FIG. 3. In one embodiment, the present invention uses each of the codewords in the first subset 82, save one codeword, as a means by which the encoder signals the decoder 80 that the stream of in-band data is beginning, a start codeword. That additional codeword of the first subset 82 that is not a start codeword may be used to signal an end to the stream of in-band data, a stop codeword. The stop codeword is optional, and more than one stop codeword may be employed as described below. The size M of the first subset 82 of codewords allows the encoder to define various parameters for the in-band data, as detailed below. Since codewords of the first subset 82 are reserved for mode selection, there remain N-M codewords available to select from using the index (i) while in the normal speech communication mode, resulting in negligible quality loss so long as M<<N. Preferably, 100M<N and most preferably 1000M<N. Thus, the size M of the first subset 82 may be selected to offer a number M of combinations of transmission quality and rate (or M−1 where one codeword of the first subset 82 is used as a stop codeword). A particular network element 12, 18, 22, 24, 32 may select a particular value for M (the number of codewords within the first subset 82) for one communication, and inform the decoder in a receiver of the selection, and select a different value of M for a different communication (or for a different segment of the original communication) based on a different data rate.

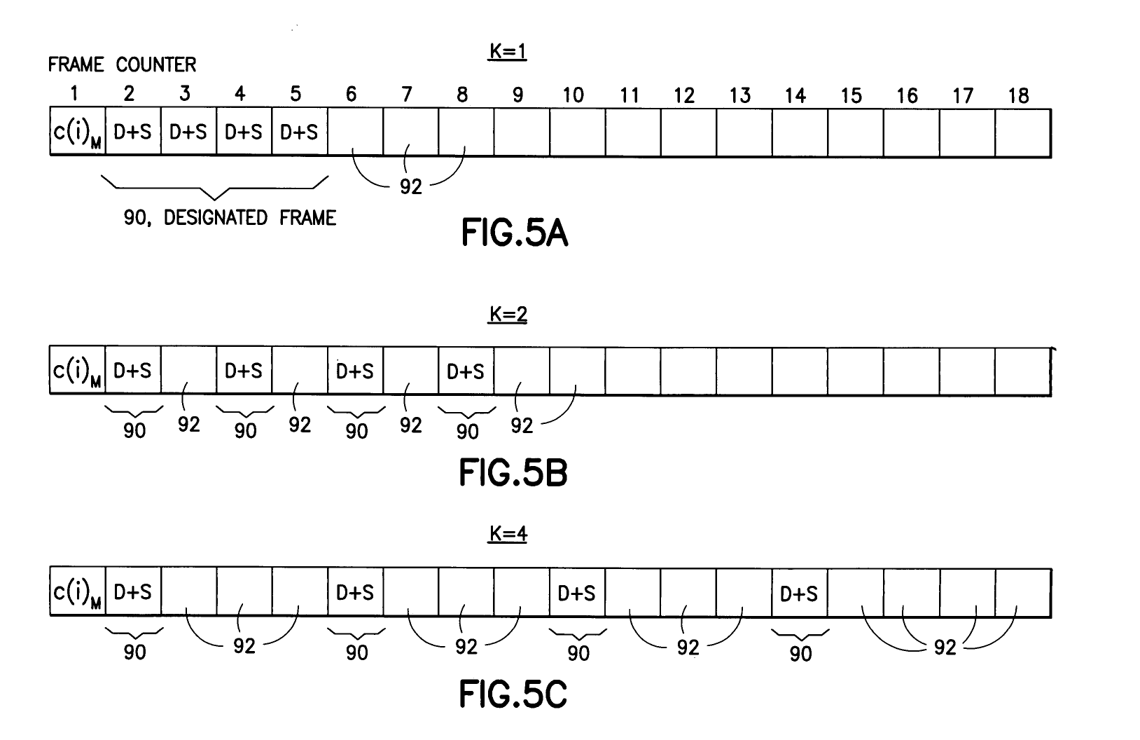

For example and with reference to FIG. 5A, assume codeword c(23)_{M}, of which its index is sent in frame number 1, is a member of the first subset 82 of codewords and that each codeword of the first subset 82 designates that the stream of in-band data will be carried in the next four frames. Four frames are selected for simplicity of explanation, and in practice the codewords in the first subset 82 optimally indicate a higher number of frames in which the in-band data will be included. The decoder sees the index for codeword c(23)_{M} in frame number 1, and anticipates that frame numbers 2-5 will include in-band data, designated by the term “D+S” within the frame (representing in-band Data plus Speech). The codeword from the first subset 82 denotes the designated frames 90 in which in-band data is carried. Absent any contrary instructions to extend or truncate the stream of in-band data from the pre-determined four frames as described below, frame numbers 2-5 will include the in-band data mixed with speech as detailed below, and frame numbers 6 et seq. are not influenced by the codeword c(23)_{M}. Non-designated frames 92 are those frames that carry speech but no in-band data.

A pre-designated length of the stream of in-band data may be extended or truncated. In the event the MS 32 that transmitted the index for codeword c(23)_{M} determines that not all four frames in the example are needed for data, it may transmit the index for a stop codeword, that is also within the first subset 82. The stop codeword informs the receiving element that the stream of in-band data is terminated, regardless of any remaining frames 90 indicated by a start codeword from the first subset 82. In the event the MS 32 that transmitted the index for the start codeword c(23)_{M} determines that more than four frames are needed for data, it need only transmit the start codeword c(23)_{M} index again (or any other start codeword index) to extend the number of designated frames 90. In the example above, the MS 32 is illustrative of any transmitter employing the present invention.

Coding of the in-band data within the stream is particularly shown at FIG. 4, which illustrates the index of one of the codewords from the first subset 82 of FIG. 3. When the index of one of the M codewords of the first subset 82 is transmitted from the encoder to the decoder, the encoder-decoder system enters a low-rate data mode of operation for the designated frames 90. For each codeword c(i) selected by the index of length L bits, a predefined subset of the L index bits, numbering D bits, is used to convey the desired in-band data. As illustrated in the example of FIG. 4, the index has a length L=36 bits that, in the prior art, are all used to search the entire codebook 58 of size N=2^{L}. In the example of FIG. 4, those L=36 bits are parsed into D=10 data bits 86, and L-D=26 bits that are used to search for a unique codeword among only a subset of the full codebook 58. The number of unique codewords that can be selected by the speech encoder is therefore reduced from N-M, which is all codewords in the second subset 84, to 2^{(L-D)}-M, which is all codewords uniquely identifiable by L-D binary bits. While the remaining codewords 84 (i.e., those not in the first subset 82) are all still available, searching the second subset 84 with only L-D bits while within the in-band data stream renders several of the codeword indices for codewords in the second subset 84 identical to one another (in the relevant L-D bit segment), thus limiting the effective number of remaining codewords to 2^{(L-D)}-M. For example, assume two codewords within the second subset 84 are identified by the following L=36 bit indices.

TABLE 1
Codebook Indices

| | L-bit Index | |
|---|---|---|
| | D-bit | |
| | segment | L-D bit segment |
| Codeword A Index | 0011011110 | 00101010101100010011001011 |
| Codeword B Index | 1011011110 | 00101010101100010011001011 |

In Table 1, the sole distinction between the index for codeword A and the index for codeword B is within the D bit segment. While within the in-band stream of data, that D-bit segment is not used to uniquely select a codeword but rather to carry the in-band data. Only the L-D segment can uniquely select a codeword while within the in-band stream, rendering the relevant L-D portion of the indices for codewords A and B identical, at least while within the in-band data stream. While the examples shown herein presume the L bits and D bits are sequential, they may instead be spread non-sequentially among all of the bits of the codeword index. The operative distinction is that in the non-designated frames 92, all of the L bits are used to search for a unique codeword, and in the designated frames, D of the L bits are used to carry in-band data.

It is only in those frames 90 designated by a codeword from the first subset 82 that data (carried by the D-segment of bits) is mixed with speech (codewords identified by the L-D-segment of the index). Therefore, only in the designated frames 90 is the effective size of the codebook 58 limited to only 2^{(L-D)}-M unique codewords. Neither the encoder nor decoder uses the D bits for data in the non-designated frames 92, so the entire index of length L is used to search the entire second subset 84 (numbering N-M unique codewords) when not within the in-band data stream. For example, assume speech and data is to be sent in frame 10, and speech only is to be sent in frames 11-12. Frame 10 may be coded according to the present invention using D bits to carry the data and L-D bits to search among 2^{L-D}-M unique codewords. It is noted that the entire index of length L may be used to search the entire codebook of size N at all times, whether within or not within the in-band data stream. However, when within the in-band stream in frame 10, the relevant L-D bits can only uniquely identify 2^{L-D}-M codewords, so the index available for searching is effectively reduced to L-D. Codewords in frames 11-12 may be selected from the entire N-member codebook, though only N-M members are available since the M codewords are reserved for designating the in-band stream. In other words, a codeword is selected from 2^{(L-D)}-M possible unique codewords in designated frame 10 (within the bit-stream of in-band data), and from N-M possible unique codewords in non-designated frames 11-12 (not within the stream of in-band data). Since a smaller number of unique codewords results in lower speech quality, the above approach uses the most limited size codebook for speech (2^{L-D}-M unique members) in only the most limited number of frames (the designated frames 90), and the maximum size codebook (N-M unique members) in all non-designated frames 92 in which in-band data is not carried.

Designating D bits to carry data and the remaining L-D bits to uniquely search the codebook allows for the speech encoder 56 to simultaneously transmit in-band data at a rate of D bits per frame/subframe while optimizing the speech quality by choosing the best of the remaining 2^{(L-D)}-M codewords. Note that in this embodiment, in-band data transmission occurs only when codebooks are used, for example, during full rate or half rate transmission in cdma2000. Speech quality loss can be controlled via the selection of D, which necessarily determines the size of the remaining codewords that are unique as detailed above. A lower rate of transmission implies a larger effective codebook 58 for use by the speech codec 56, 80, and hence better speech quality.

Large streams of in-band data carried in consecutive frames may noticeably degrade the quality of the accompanying speech. As detailed above, speech in designated frames 90 is coded from a smaller number of codeword choices than speech in non-designated frames 92. A user hearing the reconstituted speech at a receiver may not perceive a quality discrepancy for short-lived instances of speech being encoded with the smaller number of codeword choices, but that discrepancy is more likely to be perceived when the smaller number of codeword choices are used for a series of consecutive frames. To alleviate quality loss in that respect, the in-band data can be restricted to one of each group of K consecutive frames, where K is an integer greater than one. This dispersal of data over non-consecutive frames results in a lower rate of in-band data transmitted as compared to the same data rate in consecutive frames, but spreads out the affected frames in time. This aspect is described in detail below with reference to Table 2 and FIGS. 5A-5C.

When a stream of in-band data is entered, the encoder 56 can send a number of designated frames 90 (carrying data and speech) to the decoder 80 before the communication system re-enters the normal mode of operation, which may occur automatically or upon coding of a stop codeword. Designating a value of K greater than one spreads the designated frames 90 among non-designated frames 92, and each designated frame 90 alternates with K-I non-designated frames 92. If more data remains to be sent, an index identifying a codeword from the first subset 82 is again sent to the decoder to re-enter or extend the stream of in-band data, as described above with the example codeword c(23)_{M}. This feature is useful when the invention is used in an error-prone channel. The value of K can be continued or changed with transmission of the index identifying an additional reserved codeword that extends the in-band stream. Alternatively, if all desired data is sent before the designated number of frames is reached (or if the start codewords designate an open-ended stream of in-band data), the encoder signals the decoder by sending the index identifying a stop codeword.

As a specific example, assume a variable-rate speech codec that uses, for the full rate, a fixed codebook 58 with a 36-bit index (L=36). Assume further that this codebook 58 is searched every subframe, or every 5 ms. Therefore, the bandwidth required for transmission of the fixed codebook indices is 7.2 Kb/sec, representing the maximum possible in-band data rate that can be achieved. If, for example, this codebook were used for only 30% of the frames (a typical value for speech transmissions), the maximum bit rate would be 2.16 Kb/sec. For this example, set M=9 reserved codewords in the first subset 82 to signal the start or end of a stream of in-band data. Each of the different start codewords represent a different trade-off between speech quality and data throughput. Eight codewords are start codewords that signal the beginning of a stream of in-band data mixed with speech for a fixed number of frames (the designated frames that carry both in-band data and speech), and one codeword is a stop codeword that signals an end to the stream of in-band data. For each of the eight start codewords, the parameters D and K are selected as follows in Table 2.

TABLE 2
Sample In-Band Data Rates and Resulting Effective Codebook Size

| Codeword in | | | Throughput (assuming | New Codebook |
|---|---|---|---|---|
| M subset | D | K | 30% full-rate frames) | Size |
| c(1)_{M} | 5 | 1 | 300 b/sec | 2³¹ − 9 |
| c(2)_{M} | 10 | 2 | 300 b/sec | 2²⁶ − 9 |
| c(3)_{M} | 20 | 4 | 300 b/sec | 2¹⁶ − 9 |
| c(4)_{M} | 10 | 1 | 600 b/sec | 2²⁶ − 9 |
| c(5)_{M} | 20 | 2 | 600 b/sec | 2¹⁶ − 9 |
| c(6)_{M} | 15 | 1 | 900 b/sec | 2²¹ − 9 |
| c(7)_{M} | 30 | 2 | 900 b/sec | 2⁶ − 9 |
| c(8)_{M} | 20 | 1 | 1200 b/sec | 2¹⁶ − 9 |

It is noted that the actual members of the first subset 82 are preferably selected based on those codewords used least often for speech coding purposes. The examples of Table 2 are described with reference to FIGS. 5A-5C, wherein designated frames 90 carry both in-band data and speech, and are labeled D+S. Non-designated frames 92 do not carry in-band data, and are left blank in the drawings. FIG. 5A represents the instance wherein K=1, and illustrates a series of eighteen frames when the index for one of the first subset codewords c(1)_{M}, c(4)_{M}, c(6)_{M}, and c(8)_{M} from Table 2 above is transmitted in frame number 1. The frame numbering is for illustration only, and is consistent throughout each of FIGS. 5A-5C. Absent transmission of the index for another first subset codeword 82, the stream of in-band data ends at frame 5, since as assumed above, the start codewords signal the beginning of the stream of in-band signalling data that spans a fixed number of frames. The highest quality speech transmissions in this K=1 group uses codeword c(1)_{M} since it uses the largest effective codebook size (N=2³¹-9), but it necessarily also transmits in-band data at the lowest rate (300 b/sec). Conversely, the highest in-band data rate (1200 b/sec) is enabled by transmitting the index for codeword c(8)_{M}, at the cost of poorer speech quality (effective codebook size N=2¹⁶-9) for the K=1 group.

FIG. 5B represents the instance wherein K=2, and illustrates a series of eighteen frames when the index for one of the first subset codewords c(2)_{M}, c(5)_{M}, and c(7)_{M} from Table 2 above is transmitted in frame number 1. Since K=2, only one of every two consecutive frames is a designated frame that carries the in-band data plus speech. Frame numbers 2, 4, 6 and 8 are the designated frames of FIG. 5B. Absent transmission of the index for another codeword from the first subset 82, the in-band stream of data ends with frame number 8, since in the example each start codeword from the first subset designates four frames to carry data. The most accurate speech transmissions in this K=2 group uses codeword c(2)_{M} since it uses the largest number of unique codewords for this group (N=2²⁶-9), but it necessarily also transmits the in-band data at the lowest rate (300 b/sec). Conversely, the highest in-band data rate (900 b/sec) is enabled by codeword c(7)_{M}, at the cost of poorer speech quality (N=2⁶-9 unique codewords) for the K=2 group.

FIG. 5C represents the instance wherein K=4, and illustrates a series of eighteen frames when codeword c(3)_{M} from Table 2 above is transmitted in frame number 1. Since K=4, only one of every four consecutive frames carries the in-band data and speech together, and frame numbers 2, 6, 10 and 14 of FIG. 5C are the designated frames. Absent transmission of another codeword from the first subset 82, the in-band stream ends with frame number 14, (assuming the start codeword designates four frames). It is an arbitrary selection which of the K consecutive frames carries data, so long as the receiving MS 32 is aware of the proper frame in which to find it. FIG. 5C illustrates the designated frames as the first of each group of K consecutive frames, but the designated frames may instead be the second (e.g., frame numbers 3, 7, 11, and 15), the third (e.g., frame numbers 4, 8, 12, and 16), or the fourth (e.g., frame numbers 5, 9, 13, and 17) of each group of K consecutive frames. It is noted that the designated frames 90 that include in-band data and speech are derived from only 2^{L-D}-M unique codewords, while the remaining frames 92 that do not include in-band data are derived from a larger set of N-M unique codewords.

Additionally, the present invention is not limited in that the stream of in-band data ends automatically based on the start codeword 82. Instead, a start codeword 82 may signal the beginning of a stream of in-band signalling data that continues indefinitely until a stop codeword is encoded.

The particular frame carrying a start or stop codeword is still decoded by the decoder as speech. In the description above, the decoder is constrained to selecting only one codeword to provide the filter parameters for that speech, regardless of the underlying speech itself To avoid that adverse result wherein speech in the frames carrying a mode-indicating codeword index is unacceptably degraded, the present invention provides a plurality of codewords that each indicate an identical combination of D and K (the parameters of the in-band data stream). For example, rather than a single codeword per Table 2 entry, any of ten codewords may be used to indicate the various combinations of D and K (the combination of in-band data rate and effective codebook size). To indicate D=5 and K=1, the encoder may select from any of the ten codewords that designate that combination that most fits the speech to be encoded. Each of those ten codewords are within the first subset 82 of the codebook, since they indicate a mode change. The index for that codeword is then transmitted, and the decoder selects the corresponding codeword from its codebook. To indicate D=10 and K=2, the encoder may select from any of ten codewords that designate that particular combination, which are each different from the ten that designate D=5 and K=1.

Extending this principal to each of the entries in Table 2 results in eighty start codewords in the first subset, wherein each mutually exclusive group of ten codewords within the first subset 82 of the codebook 58 designate a different combination of D and K as compared to any other mutually exclusive group. Using another ten codewords to form a group of stop codewords expands the first subset 82 to ninety members. Preferably, each group consists of the same number J of codewords, in order to normalize speech quality degradation among the start and stop frames. The number of codewords in the first subset 82 is then J×V or J×(V+1), wherein V is used to indicate the number of modes, or number of combinations of D and K allowed for the in-band stream of data. Where a group of J stop codewords are used, the first subset 82 numbers J×(V+1) codewords. The value of J may be optimized based on the number of times start and stop frames are transmitted as compared to the number of other frames carrying speech, whether designated frames 90 or non-designated frames 92.

The present invention thereby enables the use of in-band low-rate data while actively controlling the quality of the transmitted speech through the selection of values for M, D and K. The in-band stream can be tailored to the data to be sent by selecting one of the start codewords from the first subset with M members, where each different start codeword represents a different trade-off between data rate and effective codebook size (and hence speech quality). The increased prevalence of VoIP for voice communications, in conjunction with a method for transmitting in-band data, allows mobile equipment manufacturers to facilitate VoIP without regard to network entities such as base stations, particularly in mobile-to-mobile communications. Thus, new applications beyond VoIP may be derived without having to overhaul the entire network infrastructure.

For the specific application of VoIP, changes to the speech codec are minimal, resulting in a minimal and controlled amount of quality degradation, with very little increase in complexity or processing required. In it's normal mode of operation, the impact to the codec is negligible. For circuit-switched applications in cdma2000, the present invention provides an opportunity to replace dim-and-burst and blank-and-burst signaling. Due to the relatively low data rates associated with in-band data from a speech codec, the most promising applications currently appear to be email and short messaging. However, other applications may become more practical in the future without departing from the broader aspects of the present invention.

While the claimed invention is described above with reference to mobile stations and VoIP, a practitioner in the art will recognize the principles of the claimed invention are applicable to other applications including those applications as discussed herein and those yet to be developed. The illustration and description above is considered to be a preferred embodiment of the claimed invention, for which numerous changes and modifications are likely to occur to those skilled in the art. It is intended in the appended claims to cover all those changes and modifications that fall within the spirit and scope of the claimed invention.

1. A method of providing in-band data within a digital speech channel, comprising:
storing in a computer readable medium a codebook comprising N codewords, each uniquely identifiable by a codeword index defining L bits;
using a designated codeword of the codebook in a first frame to identify a stream of in-band data comprising at least one designated frame apart from the first frame in which in-band data is carried; and
in the at least one designated frame, using a first portion D of the L bits of a codeword index to carry in-band data;
wherein N and L are integers greater than one, and D is an integer at least equal to one.

2. The method of claim 1 wherein in the at least one designated frame, a mutually exclusive second portion L-D of the L bits of the index are available to search the codebook.

3. The method of claim 1 wherein the designated codeword is a start codeword, and the at least one designated frame is subsequent to the first frame.

4. The method of claim 3 wherein the codebook defines at least one stop codeword, the method further comprising using the designated stop codeword in a frame subsequent to the at least one designated frame to terminate the stream of in-band data.

5. The method of claim 4 wherein the designated codeword identifies a start to a continuous stream of in-band data, and using the designated stop codeword terminates the continuous stream of in-band data.

6. The method of claim 1 wherein using a designated codeword comprises using a first designated codeword in a first frame to select a first data transmission rate within a first stream, the method further comprising using a second designated codeword in a second frame subsequent to the at least one designated frame in the first stream to select a second data transmission rate and to identify a second stream of in-band data.

7. The method of claim 6 wherein the first designated codeword selects a first data transmission rate and first effective codebook size for the first stream, and the second designated codeword selects a second data transmission rate and second effective codebook size for the second stream, wherein the first data transmission rate is one of greater than and less than the second data transmission rate and the first effective codebook size is the other of greater than and less than the second effective codebook size.

8. The method of claim 7 wherein the first data transmission rate is less than the second data transmission rate.

9. The method of claim 6 wherein the first designated codeword is selected from among a first group of designated codewords that each select a first data transmission rate and the second designated codeword is selected from among a second group of designated codewords that each select a second data transmission rate that differs from the first data transmission rate.

10. The method of claim 9 wherein each codeword of the first group selects an identical first combination of data transmission rate and effective codebook size, and each codeword of the second group selects an identical second combination of data transmission rate and effective codebook size that differs from the first combination.

11. The method of claim 10 wherein the codewords of the first and second group are start codewords, the method further comprising using one of a group of designated stop codewords in a frame subsequent to the at least one designated frame to terminate the stream of in-band data.

12. The method of claim 10 wherein the number of codewords in the first and second group are identical.

13. The method of claim 1 further comprising:
in at least one frame that is not a designated frame, using all of the L bits to uniquely select a codeword from among all codewords in the codebook except designated codewords that identify one of a start and stop of a stream of in-band data.

14. The method of claim 1 wherein the designated codeword identifies a stream of in-band data comprising a plurality of designated frames.

15. The method of claim 14 wherein each of the plurality of designated frames are dispersed among K non-designated frames that do not carry in-band data, K being an integer greater than one.

16. The method of claim 14 wherein the plurality of designated frames is a fixed number of frames, said fixed number one of a predetermined number that is constant for all designated codewords that identify a start of a stream of in-band data, and a number that varies among at least two designated codewords that identify a start of a stream of in-band data.

17. In a transmitter comprising a codebook of 2^{L} codewords, each codeword uniquely identifiable over other codewords in the codebook by a codeword index defining L bits, and an encoder for encoding speech into frames using the codebook, the improvement comprising:
the encoder using a designated codeword in a first frame to identify a stream of in-band data defined by at least one designated frame in which speech and data are carried, wherein, in the designated frame, the encoder encodes data using a first portion D of the L bits of a codeword index, wherein L is an integer greater than one and D is an integer at least equal to one.

18. The transmitter of claim 17 wherein, in the at least one designated frame, a mutually exclusive second portion L-D of the L bits of the index are available for the encoder to search the codebook.

19. The transmitter of claim 17 wherein the designated codeword is a start codeword, and the at least one designated frame is subsequent to the first frame.

20. The transmitter of claim 19 wherein the codebook defines at least one stop codeword, and the encoder uses the stop codeword to identify an end of the stream of in-band data.

21. The transmitter of claim 17 wherein the encoder encodes a first designated codeword in the first frame to select a first combination of data transmission rate and effective codebook size within a first stream of in-band data, and the encoder encodes a second designated codeword in a second frame subsequent to the at least one designated frame in the first stream to select a second combination of data transmission rate and effective codebook size within a second stream of in-band data.

22. The transmitter of claim 21 wherein the first designated codeword selects a first value for D, and the second codeword determines a second value for D.

23. The transmitter of claim 21 wherein the first designated codeword is selected from among a first group of designated codewords that each select a first data transmission rate and the second designated codeword is selected from among a second group of designated codewords that each select a second data transmission rate that differs from the first data transmission rate.

24. The transmitter of claim 23 wherein each codeword of the first group selects an identical first combination of data transmission rate and effective codebook size, and each codeword of the second group selects an identical second combination of data transmission rate and effective codebook size that differs from the first combination.

25. The transmitter of claim 24 wherein the codewords of the first and second group are start codewords, wherein the encoder uses one of a group of designated stop codewords in a frame subsequent to the at least one designated frame to terminate the stream of in-band data.

26. The transmitter of claim 24 wherein the number of codewords in the first and second group are identical.

27. The transmitter of claim 17 wherein the improvement further comprises:
in at least one frame that is not a designated frame, the encoder using all of the L bits to uniquely select a codeword from among all codewords in the codebook, except designated codewords that identify one of a start and a stop of a stream of in-band data.

28. The transmitter of claim 17 wherein the stream of in-band data is defined by a plurality of designated frames that are each dispersed among K non-designated frames that do not carry in-band data, K being an integer greater than one.

29. The transmitter of claim 17 within a mobile station.

30. In a receiver comprising a codebook of 2^{L} codewords, each codeword uniquely identifiable over other codewords in the codebook by a codeword index defining L bits, and a decoder for using the codebook to decode speech, the improvement comprising:
the decoder decoding a designated codeword in a first frame that identifies an in-band stream of data defined by at least one designated frame in which speech and data are carried, wherein, in the designated frame, the decoder decodes data using a first portion D of the L bits of a codeword index, wherein L is an integer greater than one and D is an integer at least equal to one.

31. The receiver of claim 30, wherein, in the at least one designated frame, a mutually exclusive second portion L-D of the L bits of the index are available to the decoder to search the codebook.

32. The receiver of claim 30 wherein the designated codeword is a start codeword, and the at least one designated frame is subsequent to the first frame.

33. The receiver of claim 32 wherein the codebook defines at least one stop codeword, and the decoder uses the stop codeword to identify an end to the stream of in-band data.

34. The receiver of claim 30 wherein the decoder decodes a first designated codeword in the first frame to select a first combination of data transmission rate and effective codebook size within a first stream of in-band data, and the decoder decodes a second designated codeword in a second frame to select a second combination of data transmission rate and effective codebook size within a second stream of in-band data.

35. The receiver of claim 22 wherein the designated frames are not consecutive.

36. The receiver of claim 22 disposed within a mobile station.
